(19) United States
(12) Patent Application Publication
(10) Pub. No.: US 2017/0223128 A1
(43) Pub. Date: Aug. 3, 2017

(54) INTERMEDIARY FOR MULTIPLE-TRANSPORT CLIENT-DEVICE COMMUNICATIONS

(71) Applicant: Google Inc., Mountain View, CA (US)

(72) Inventors: Roman Yurievich Shuvaev, Saint Petersburg (RU); Anton Sergeevich Mukhin, Saint Petersburg (RU); Christian Andrew Warren, San Francisco, CA (US); Yevgeniy Alexandrovich Gutnik, Cupertino, CA (US); Pavel Evgenievich Podivilov, Saint Petersburg (RU); Robert Toscano, San Francisco, CA (US); Yuri Gennadievich Dolgov, Saint Petersburg (RU)

(21) Appl. No.: 15/500,709

(22) PCT Filed: Aug. 6, 2014
(86) PCT No.: PCT/RU2014/000589

§ 371 Date: Jan. 31, 2017

(51) Int. Cl. H04L 29/08; H04W 4/00; H04L 29/06

(52) U.S. Cl. CPC H04L 67/28; H04L 67/125; H04L 67/306; H04L 65/1073; H04W 4/005

(57) ABSTRACT

An example technique includes storing, by an intermediary, a device registration information including at least for a target device, the device registration information including information identifying one or more commands supported by the device, and a device-specific ranking of each of a plurality of transports, receiving, by the intermediary a first message sent via a transport supported by the client application including a device identifier to identify a target device of a plurality of registered devices and a command information identifying a command that is supported by the target device and to be performed by the target device, selecting, by the intermediary, a transport supported by the target device based on the device-specific ranking of the plurality of transports supported by the target device, and sending, by the intermediary to the target device via the selected transport, a second message including at least the command information.

### TECHNICAL FIELD

This description relates to communications, and in particular, to an intermediary for multiple-transport client-device communications.

### BACKGROUND

Machine-to-machine (M2M) and Internet of Things (IoT) technologies hold a promise to interconnect thousands, if not millions, of electronic devices together for exchanging data over wired or wireless networks.

In example known home or business contexts, a user may have may have deployed several electronic devices for personal or business use. Each of the devices may be set up with security features (e.g., user authentication and authorization protocols) so that the devices can be used or operated only by the user or by another user authorized by the owner. Because access control in these known environments may not be efficient, may be difficult to manage, can result in undesirable sharing scenarios, and/or so forth, improvements over these known systems is needed.

Consideration is now being given to methods and systems by which a user can share or make a device available for use by another user.

### SUMMARY

According to an example implementation, a computer-implemented method is provided for executing instructions stored on a non-transitory computer-readable storage medium. The method may include storing, by an intermediary, a device registration information for one or more devices including at least for a target device, the device registration information including information identifying one or more commands supported by the device, and a device-specific ranking of each of a plurality of transports supported by the device for communicating with the intermediary, receiving, by the intermediary from a client application associated with a user account, a first message sent via a transport supported by the client application, the first message including a device identifier to identify a target device of a plurality of registered devices and a command information identifying a command that is supported by the target device and to be performed by the target device, selecting, by the intermediary, a transport supported by the target device based on the device-specific ranking of the plurality of transports supported by the target device, and sending, by the intermediary to the target device via the selected transport supported by the target device, a second message including at least the command information.

In an example implementation, the method may further include storing, by the intermediary, user account information for the user account, the user account information including at least information identifying one or more transports supported by the client application for communicating with the intermediary including information identifying a first transport used by a first client application associated with the user account to send messages to the intermediary, and a second transport used by a second client application associated with the user account to receive messages from the intermediary, the first client application being different from the second client application.

In an example implementation, the receiving may include receiving, by the intermediary from a first client application and via a first transport that are associated with the user account, the first message, and wherein the method further includes forwarding a notification received from the target device to a second client application and via a second transport that are associated with the user account, wherein the first client application and the second client application are different applications.

In an example implementation, the receiving may include receiving, by the intermediary from a first client application running on a first client computing device and via a first transport that are associated with a user account, the first message, and wherein the method further includes forwarding, by the intermediary, a notification received from the target device to a second client application running on a second client computing device and via a second transport that are associated with the user account, wherein the first client application and the second client application are different applications, and wherein the first client computing device and the second client computing device are different computing devices.

In an example implementation, the method may further include receiving, by the intermediary from the target device via the selected transport supported by the target device, a third message including a reply indicating that the command was performed by the target device, and sending, by the intermediary to the client application, a fourth message including the reply.

In an example implementation, the method may further include adjusting, by the intermediary, the device-specific ranking of the plurality of transports supported by the target device based on feedback provided by one or more of the devices to the intermediary.

In an example implementation, the method may further include determining, by the intermediary, a characteristic of the first message, adjusting the device-specific ranking of the plurality of transports supported by the target device based on the determined characteristic, and wherein the selecting includes selecting, by the intermediary, a transport supported by the target device based on the adjusted device-specific ranking of the plurality of transports.

According to an example implementation, the adjusting may include adjusting the device-specific ranking of the plurality of transports supported by the target device based on one or more of the following: a size of a payload of the first message, including the command information, to be delivered to the target device, whether communication of a payload of the first message, including the command information, to the target device involves communication of audio or video signals, whether performance, by the target device, of the command involves communication of audio or video signals, and any latency requirements for communication of the command information to the target device.

In an example implementation, the method may further include adjusting the device-specific ranking of the plurality of transports supported by the target device based on one or more of the following: a success rate in sending messages from the intermediary to one or more of the devices via one or more of the transports, and a current availability of one or more of the transports.

In an example implementation, the method may further include determining that a size of the second message, including the command information, is greater than a threshold, and adjusting the device-specific ranking of the plurality of transports supported by the target device to favor one or more transports that are capable of handling messages greater than the threshold.

In an example implementation, the method may further include determining that the command information is requesting audio or video data services, and adjusting the device-specific ranking of the plurality of transports supported by the target device to favor one or more transports that are capable of providing audio or video data delivery or streaming services.

In an example implementation, the transport supported by the client application may include a communications procol supported by the client application, and the transport supported by the target device may include a communications procol supported by the target device.

According to an example implementation, an apparatus may include a processor that is configured to store, by an intermediary, a device registration information for one or more devices including at least for a target device, the device registration information including information identifying one or more commands supported by the device, and a device-specific ranking of each of a plurality of transports supported by the device for communicating with the intermediary, receive, by the intermediary from a client application associated with a user account, a first message sent via a transport supported by the client application, the first message including a device identifier to identify a target device of a plurality of registered devices and a command information identifying a command that is supported by the target device and to be performed by the target device, select, by the intermediary, a transport supported by the target device based on the device-specific ranking of the plurality of transports supported by the target device, and send, by the intermediary to the target device via the selected transport supported by the target device, a second message including at least the command information.

According to another example implementation, a computer program product is tangibly embodied on a non-transitory computer-readable storage medium and includes instructions that, when executed, are configured to cause at least one processor to: store, by an intermediary, a device registration information for one or more devices including at least for a target device, the device registration information including information identifying one or more commands supported by the device, and a device-specific ranking of each of a plurality of transports supported by the device for communicating with the intermediary, receive, by the intermediary from a client application associated with a user account, a first message sent via a transport supported by the client application, the first message including a device identifier to identify a target device of a plurality of registered devices and a command information identifying a command that is supported by the target device and to be performed by the target device, select, by the intermediary, a transport supported by the target device based on the device-specific ranking of the plurality of transports supported by the target device, and send, by the intermediary to the target device via the selected transport supported by the target device, a second message including at least the command information.

According to an example implementation, an apparatus may include means for storing, by an intermediary, a device registration information for one or more devices including at least for a target device, the device registration information including information identifying one or more commands supported by the device, and a device-specific ranking of each of a plurality of transports supported by the device for communicating with the intermediary, means for receiving, by the intermediary from a client application associated with a user account, a first message sent via a transport supported by the client application, the first message including a device identifier to identify a target device of a plurality of registered devices and a command information identifying a command that is supported by the target device and to be performed by the target device, means for selecting, by the intermediary, a transport supported by the target device based on the device-specific ranking of the plurality of transports supported by the target device, and means for sending, by the intermediary to the target device via the selected transport supported by the target device, a second message including at least the command information.

According to another example implementation, a computer-implemented method is provided for executing instructions stored on a non-transitory computer-readable storage medium. The method may include receiving, by the intermediary from a client application associated with a user account, a first message sent via a transport supported by the client application, the first message including a device identifier to identify a target device of a plurality of registered devices, a command information identifying a command that is supported by the target device and to be performed by the target device, and a response maximum wait time field that identifies a maximum wait time before the intermediary will send a response to the client application in response to receiving the first message, identifying, by the intermediary based on a stored device registration information for the target device, a transport supported by the target device, sending, by the intermediary to the target device via the identified transport supported by the target device, a second message including at least the command information, and sending, by the intermediary to the client application at a time not later than a time indicated by the response maximum wait time field, a response to the first message that includes at least a command status that identifies a status of a performance of the command by the target device.

According to an example implementation, the command status in the response is either a command received status indicating that the command has been received but not yet performed by the target device, or a command performed status indicating that the target device has performed the command.

According to an example implementation, the sending, by the intermediary to the client application at a time not later than a time indicated by the response maximum wait time field, a response to the first message may include: determining, by the intermediary, that a response has not been received by the intermediary from the target device indicating that the target device has performed the command, and sending, by the intermediary to the client application at a time not later than the time indicated by the response maximum wait time field, a response to the client application including a command status indicating that the command has not been performed by the target device.

According to an example implementation, the response may include a first response indicating that the command has been received but not yet performed by the target device, the method further including receiving, by the intermediary from the client application after a time indicated by the response maximum wait time field, a third message requesting a command result from the target device performing the command, receiving, by the intermediary from the target device at a time after a time indicated by the response maximum wait time field, a second response indicating that the command was performed and including a command result, and sending, by the intermediary to the client application, a third response including a command status indicating that the command has been performed by the target device and including the command result.

According to an example implementation, the sending, by the intermediary to the client application at a time not later than a time indicated by the response maximum wait time field, a response to the first message may include receiving, by the intermediary from the target device at a time before a time indicated by the response maximum wait time field, a first response indicating that the command was performed and including a command result, and sending, by the intermediary to the client application at a time not later than the time indicated by the response maximum wait time field, a second response including a command status indicating that the command has been performed by the target device and including the command result.

According to an example implementation, an apparatus may include a processor that is configured to receive, by the intermediary from a client application associated with a user account, a first message sent via a transport supported by the client application, the first message including a device identifier to identify a target device of a plurality of registered devices, a command information identifying a command that is supported by the target device and to be performed by the target device, and a response maximum wait time field that identifies a maximum wait time before the intermediary will send a response to the client application in response to receiving the first message, identify, by the intermediary based on a stored device registration information for the target device, a transport supported by the target device, send, by the intermediary to the target device via the identified transport supported by the target device, a second message including at least the command information, and send, by the intermediary to the client application at a time not later than a time indicated by the response maximum wait time field, a response to the first message that includes at least a command status that identifies a status of a performance of the command by the target device.

According to an example implementation, an apparatus may include means for receiving, by the intermediary from a client application associated with a user account, a first message sent via a transport supported by the client application, the first message including a device identifier to identify a target device of a plurality of registered devices, a command information identifying a command that is supported by the target device and to be performed by the target device, and a response maximum wait time field that identifies a maximum wait time before the intermediary will send a response to the client application in response to receiving the first message, means for identifying, by the intermediary based on a stored device registration information for the target device, a transport supported by the target device, means for sending, by the intermediary to the target device via the identified transport supported by the target device, a second message including at least the command information, and means for sending, by the intermediary to the client application at a time not later than a time indicated by the response maximum wait time field, a response to the first message that includes at least a command status that identifies a status of a performance of the command by the target device.

According to an example implementation, a computer program product is tangibly embodied on a non-transitory computer-readable storage medium and includes instructions that, when executed, are configured to cause at least one processor to receive, by the intermediary from a client application associated with a user account, a first message sent via a transport supported by the client application, the first message including a device identifier to identify a target device of a plurality of registered devices, a command information identifying a command that is supported by the target device and to be performed by the target device, and a response maximum wait time field that identifies a maximum wait time before the intermediary will send a response to the client application in response to receiving the first message, identify, by the intermediary based on a stored device registration information for the target device, a transport supported by the target device, send, by the intermediary to the target device via the identified transport supported by the target device, a second message including at least the command information, and send, by the intermediary to the client application at a time not later than a time indicated by the response maximum wait time field, a response to the first message that includes at least a command status that identifies a status of a performance of the command by the target device.

According to another example implementation, a computer-implemented method is provided for executing instructions stored on a non-transitory computer-readable storage medium. The method includes receiving, by the intermediary from a client application associated with a user account, a first message sent via a transport supported by the client application, the first message including a device identifier to identify a target device of a plurality of registered devices, a command information identifying a command that is supported by the target device and to be performed by the target device, determining that a payload to be delivered to the target device, including at least the command information, is greater in size than a threshold size, sending, by the intermediary to the target device via a first transport supported by the target device, a second message including a notification of the command information for the target device, receiving, by the intermediary from the target device via a second transport supported by the target device, a third message including a request for the command information for the target device, and sending, by the intermediary to the target device via the second transport, a fourth message that includes the command information including at least the command.

According to an example implementation, the fourth message may include at least the device identifier that identifies the target device and the command information that includes a command name that identifies the command and a command identifier associated with the command information.

According to an example implementation, the command information further includes a command creation time that identifies when the intermediary received the command from the client application, and an expiration time that identifies a time when the command expires after which the target device should not perform the command if not already performed.

According to an example implementation, the first transport supported by the target device supports at least a push-based communications that allows the intermediary to initiate a data transfer to the target device, and wherein the second transport supported by the target device supports a pull-based communications that allows the target device to initiate data communications with the intermediary.

According to an example implementation, the first transport is unable to deliver payloads that are larger than the threshold size.

According to an example implementation, wherein the third message may include a request for the command information for the target device, the request including at least a command identifier associated with the command information and the device identifier to identify the target device.

According to an example implementation, an apparatus may include a processor that is configured to receive, by the intermediary from a client application associated with a user account, a first message sent via a transport supported by the client application, the first message including a device identifier to identify a target device of a plurality of registered devices, a command information identifying a command that is supported by the target device and to be performed by the target device, determine that a payload to be delivered to the target device, including at least the command information, is greater in size than a threshold size, send, by the intermediary to the target device via a first transport supported by the target device, a second message including a notification of the command information for the target device, receiving, by the intermediary from the target device via a second transport supported by the target device, a third message including a request for the command information for the target device, and send, by the intermediary to the target device via the second transport, a fourth message that includes the command information including at least the command.

According to another example implementation, a computer program product is tangibly embodied on a non-transitory computer-readable storage medium and includes instructions that, when executed, are configured to cause at least one processor to receive, by the intermediary from a client application associated with a user account, a first message sent via a transport supported by the client application, the first message including a device identifier to identify a target device of a plurality of registered devices, a command information identifying a command that is supported by the target device and to be performed by the target device, determine that a payload to be delivered to the target device, including at least the command information, is greater in size than a threshold size, send, by the intermediary to the target device via a first transport supported by the target device, a second message including a notification of the command information for the target device, receiving, by the intermediary from the target device via a second transport supported by the target device, a third message including a request for the command information for the target device, and send, by the intermediary to the target device via the second transport, a fourth message that includes the command information including at least the command.

According to an example implementation, an apparatus may include means for receiving, by the intermediary from a client application associated with a user account, a first message sent via a transport supported by the client application, the first message including a device identifier to identify a target device of a plurality of registered devices, a command information identifying a command that is supported by the target device and to be performed by the target device, means for determining that a payload to be delivered to the target device, including at least the command information, is greater in size than a threshold size, means for sending, by the intermediary to the target device via a first transport supported by the target device, a second message including a notification of the command information for the target device, means for receiving, by the intermediary from the target device via a second transport supported by the target device, a third message including a request for the command information for the target device, and means for sending, by the intermediary to the target device via the second transport, a fourth message that includes the command information including at least the command.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating a system according to an example implementation.

FIG. 2 is a flow chart illustrating operation of an intermediary in which a command is received from a client application and forwarded to a device according to an example implementation.

FIG. 3 is a diagram illustrating operation of an intermediary according to an example implementation.

FIG. 4 is a flow chart illustrating operation of an intermediary in which information is received from a device and forwarded to a client application according to an example implementation.

FIG. 5 is a diagram illustrating operation of an intermediary according to another example implementation.

FIG. 6 is a flow chart illustrating operation of an intermediary according to an example implementation.

FIG. 7 is a flow chart illustrating operation of an intermediary according to another example implementation.

FIG. 8 is a flow chart illustrating operation of an intermediary according to another example implementation.

FIG. 9 shows an example of a generic computer device and a generic mobile computer device, which may be used with the techniques described here.

### DETAILED DESCRIPTION

This document describes an intermediary for multiple-transport client-device communications. According to an example implementation, an intermediary may operate as a multiple-transport interface between client applications or clients, and devices. In this manner, the intermediary may allow client applications and devices to communicate or exchange information, even though the client applications and devices may not necessarily share a same transport. The intermediary may receive, from a client application via a first transport supported by the client application, a first message that may include a device ID identifying a target device and a command to be performed by the target device. The intermediary may determine a transport supported by the target device, for example, based on registration information for the target device stored in a database. The intermediary may then forward the command to the target device via a second message that is sent via the second transport that is supported by the target device. In a similar manner, the intermediary may receive a message including a notification (or other information) from a device via a device-supported transport, may identify a client application-supported transport, and may forward the notification in another message to the client application via the client application-supported transport.

According to another example implementation, an intermediary may store device registration information for at least a target device. The device registration information may, for example, include information identifying one or more commands supported by the target device and a device-specific ranking of each of a plurality of transports supported by the target device. The intermediary may select a transport supported by the target device based on the device-specific ranking of the plurality of transports. The intermediary may send a message, which may include command information, to the target device via the selected transport. The intermediary may also adjust or update the device-specific ranking of the plurality of transports supported by the target device based on one or more criteria, such as, for example, based on: a success rate or failure rate for one or more transports in communicating or delivering messages to one or more devices, current availability of one or more of the transports, one or more characteristics of a message or payload to be forwarded to the target device (e.g., such as size of payload or message, whether a command or payload to be forwarded to the target device relates to communication of audio or video signals, any latency requirements for the payload or target device, reliability requirements), feedback from a client application or from one or more devices regarding one or more of the transports, or other criteria.

According to another example implementation, the intermediary may receive a message from a client application including command information to be forwarded to a target device and a response maximum wait time field that identifies a maximum wait time before the intermediary sends a response to the client application. For example, the intermediary may send to the client application, at a time not later than a time indicated by the response maximum wait time field, a response to the first message that includes at least a command status. The command status may be, for example, a command received status if the command has been received but not yet performed, or may include a command performed status if the command has been performed.

According to yet another example implementation, the intermediary may receive a first message including a payload including a command information and a device identifier to identify a target device. The intermediary may determine that the size of the payload to be delivered to the target device is greater than a threshold size. The intermediary may then send a second message (including a notification) to the target device via a first transport supported by the target device. The notification may provide an indication of the command information to be delivered to the target device. For example, the command information may be omitted from the second message or notification. The intermediary may receive, via a second transport supported by the target device, a request from the target device for the command information. The intermediary may then send, via the second transport, the command information to the target device. For example, the second transport may be capable of delivering payloads or message sizes greater than the threshold size.

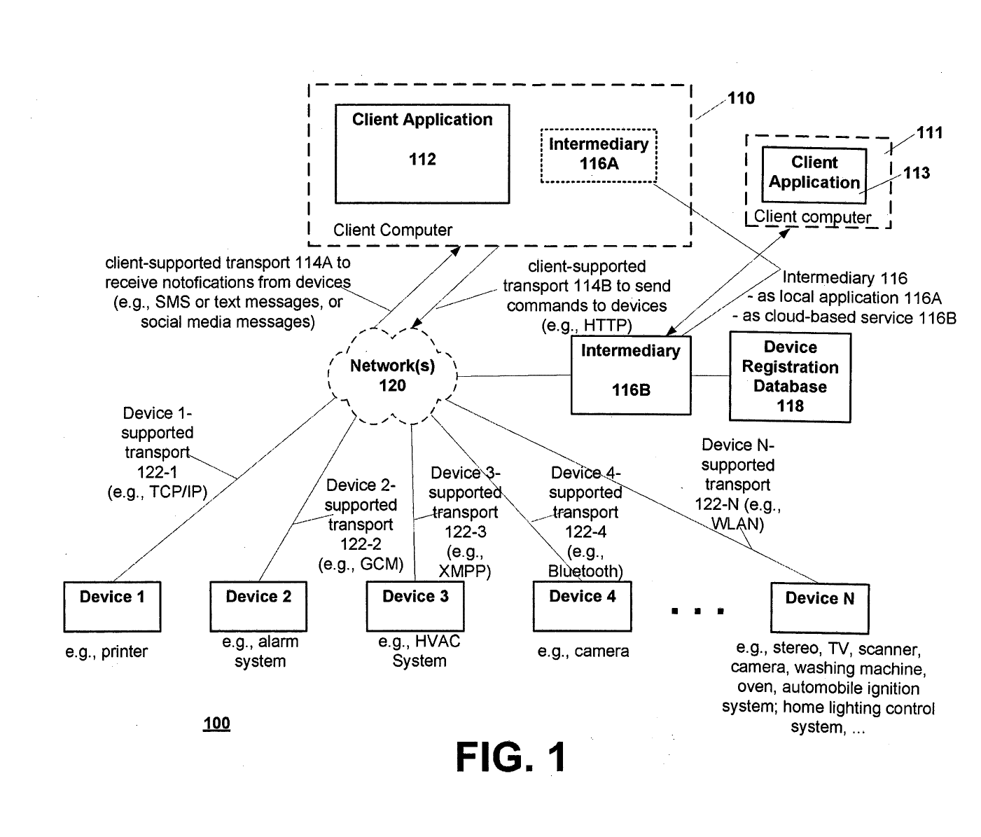

FIG. 1 is a block diagram illustrating a system 100 according to an example implementation. System 100 may include a number of computing devices, such as client computer 110, client computer 112, and devices 1, 2, 3, 4 . . . N. One or more of the computing devices may include, for example, one or more of a processor or processing logic, memory, software or firmware to be executed by the processor/processing logic, and a network interface. An intermediary 116 may be provided, either as a local intermediary 116A, which may be an application running on a client computer 110, or as intermediary 116B, which may be, for example, a cloud-based intermediary service provided on a network or server, or both intermediaries 116A and 116B may be provided. In general, reference herein to intermediary 116 may include an intermediary implemented as either intermediary 116A or intermediary 116B.

Client computer 110 may include one or more client applications, such as client application 112. Similarly, client computer 111 may also include a client application 113. Client computer 110 and/or client computer 111 may be, for example, a personal computer, laptop, mobile computing device, netbook, smart phone, as examples, or other computing device. Client application 112 and/or client application 113 may include, for example, a web browser, a texting application, a social media messaging application, as examples, or other application. A user may have (or may use) one or more client computers or computing devices, such as client computers 110 and 111. For example, a user may have a laptop with a web browser and an email application, as example client applications, and a smart phone may have a texting application and a web browser, as additional client applications. A user may have a user account, e.g., with a user ID and password, so the user can log in to receive one or more services, e.g., via client applications 112 and/or 113.

Client computers 110 and 111 may be connected to a network(s) 120. Network(s) 120 may include one or more networks, such as a Local Area Network (LAN), Wireless Local Area Network (WLAN), a Wide Area Network (WAN) such as a 3G or 4G data network or the Internet, as examples, or any other network.

In an example implementation, client applications 112 and 113 may be associated with a user account. For example, a user (of a user account) may use client application 112 (on client computer 110) and client application 113 (on client computer 111) to communicate with other network nodes or computing devices, e.g., over one or more networks. Although not shown in FIG. 1, other client computers or computing devices and client applications running thereon may be provided for use by other users or other user accounts.

According to an example implementation, one of the services that a user may receive, via his/her user account and/or client application, is the services provided by intermediary 116 to facilitate multiple-transport client-device communications. Intermediary 116 may operate as a multiple-transport network intermediary between one or more client applications and one or more devices. In an example implementation, intermediary 116 may be provided, for example, as either intermediary 116A, which may be a local application (e.g., including a library of functions which may be called by client 112) running on client computer 110, or as intermediary 116B, which may be, for example, a cloud-based intermediary service provided on a network (e.g., on a network server). Intermediary 116B may be connected to networks(s) 120. Intermediary 116 may, for example, allow a client application, operating on behalf of a user account to communicate with one or more devices (such as devices 1, 2, 3, 4, . . . N shown in FIG. 1) via intermediary 116, even though the client application 112 and the devices are not necessarily compatible in terms of transports or communications protocols.

According to an example implementation, client application 112, running on client computer 110 may use intermediary 116A (e.g., running locally on client computer 110) to communicate with one or more local devices (e.g., devices that are connected via a local wired connection/network or a local wireless connection/network, or devices that are in close proximity to the client application 110 where a direct client application-device communication may occur, such as in a device-to-device or D2D wireless network). For example, devices that are connected to client computer 110 via Bluetooth wireless connection, Local Area Network (LAN) or a Wireless Local Area Network (WLAN) may be considered local devices to client application 110. Thus, client application 112, running on client computer 110, may use intermediary 116A, also running on client computer 110, to communicate with one or more local devices (devices that are local to client computer 110).

However, with respect to client computer 110 or client application 112 (as an example), other devices may be considered to be non-local devices (or remote devices), such as devices that are not in close proximity to client computer 110 or devices that are accessible by client computer 110 only through a Wide Area Network (WAN), such as the Internet. According to an example implementation, client application 112 may use intermediary 116B (e.g., provided as a cloud based service on a network, and not locally running on client computer 110) to access both (or either) local devices (e.g., devices local to client computer 110/client application 112) and remote (or non-local) devices.

According to an example implementation, intermediary 116 may receive, from client application 112, a first message (e.g., including a device ID identifying a target device and a command to be performed by the target device) via a first transport that is supported by the client application 112 (a client-supported transport). Intermediary 116 may determine (or identify) a second transport supported by the target device (a device-supported transport), for example, based on registration information for the target device stored in a database 118. Intermediary 116 may then forward the command to the target device via a second message that is sent via the second transport that is supported by the target device. In a similar manner, intermediary 116 may receive a first message including a notification (or information) from a device via a device-supported transport, may identify a client-supported transport, and may forward the notification in a second message to the client application via the identified client-supported transport. More details are provided below.

According to an example implementation, one or more applications on client computer 110 (as an example) may communicate with one or more devices via network(s) 120, and via intermediary 116. Network(s) 120 may include one or more routers, a wireless LAN router, or other network equipment. According to an example implementation, client computer 110 and/or client application 112 may support one or more transports (client-supported transports), where a transport may include a channel, a communications technology and/or a communications protocol or standard that may allow computing devices to communicate. For example, if client application 112 is a web browser, the client application 112 may support transports such as Hypertext Transfer Protocol (HTTP), Secure Sockets Layer (SSL) or other protocol or communications standard. If client computer 110 is a smart phone, and client application 112 is a text messaging application, then the client application 112 may support SMS (short message service) or a text messaging protocol as a transport. If client application 112 is a specific social media application or social media messaging application, then the client application 112 may support the standards or communications protocol(s), as a transport, to allow transmission and/or reception of social media messages. If client application 112 is an email application, then client application 112 may, for example, support at least an email protocol as a transport (e.g., one or more email protocols, such as POP (Post Office Protocol), IMAP (Internet Message Access Protocol) and MAPI (Messaging Application Programming Interface). These are a few examples, and many other applications and transports (or communications protocols) may be used. By supporting a transport, a client computer or client application, or a device, may typically include any logic, software, protocol stack, etc., that may be used or necessary to implement such communications technology, protocol or standard of such transport, for example.

According to an example implementation, multiple applications may be associated with a user account, and each client application may support or use a different transport. In addition, a first transport may be used (or supported) by a first client application associated with the user account to send messages to the intermediary 116, and a second transport may be used (or supported) by a second client application associated with the user account to receive messages from the intermediary 116. For example, a user (of a user account) may use a first client application (e.g., a web browser) running on client computer 110, which supports or uses HTTP (Hyper-Text Transfer Protocol), to send or provide commands or other information to intermediary 116 to be forwarded to one or more devices. Similarly, for example, the user (of the user account) may use a second client application (e.g., a messaging application) running on client computer 110, which supports or uses SMS or other texting protocol, to receive notifications or other information from intermediary 116. Thus, in this example, a first application and associated transport may be used by a user/user account to send messages to intermediary 116, and a second application and associated transport (e.g., which may be different from the first application and associated transport) may be used by a user/user account to receive messages from intermediary 116. In another example implementation, multiple applications and multiple transports may be used by a user/user account to send messages to intermediary 116 and to receive messages from intermediary 116.

As shown in FIG. 1, multiple devices (e.g., device 1, device 2, device 3, device 4, . . . device N) are shown as being coupled to client computer 110, client computer 111 and intermediary 116, either directly or via a network(s) 120. Each of the devices may be any type of electronic device, and one or more of these devices may include a processor or controller, memory and a network interface to send and receive communications or messages, e.g., via Ethernet, Wireless Local Area Network (WLAN) network, via Bluetooth wireless connection, or other network interface/technology, as these are merely some examples. The devices may be any type of devices, e.g., where it may be desirable or advantageous to control such a device by sending a command to the device, or desirable or advantageous to receive messages or information (e.g., notifications) from the device. In an example implementation, by a user/user account registering a device with intermediary 116, a client application 112 associated with the user account may send commands to the device, and may receive notifications and/or other communications from the device, for example.

Example devices (and illustrative example commands/notifications) may include: a printer (e.g., to allow an application send commands to print a page and receive notifications regarding printer status), an alarm system (e.g., to send commands to arm or disarm or to receive notifications that the alarm has been triggered), HVAC (heating ventilation and air condition system) (e.g., to send commands to adjust a thermostat in one or more zones or to receive a notification as to the temperature in one or more zones, or to receive a notification that the air filter should be replaced or that a malfunction has been detected), a camera (to send a command to take a picture, being video recording, or receive a notification that the camera is out of memory/storage), a stereo (to send a command to adjust the volume, or select a different input for audio signals), a television, a digital video recorder (DVR) or other audio/video equipment (e.g., to send a command to record a TV program or receive a notification that a specific program is unavailable, or a malfunction was detected in the equipment), a scanner (e.g., to send a command to scan a document or receive a notification that the scanner is out of toner or paper), a washing machine (to send a command to wash a load of clothes, or to receive a notification of a load of wash has finished washing or a notification of a washing machine malfunction or imbalance), an oven (e.g., to send a command to preheat lower oven to 350 degrees, to set a cooking timer, or to receive a notification that the oven is done preheating, or that a timer has gone off) or other home appliance, a home lighting control system (e.g., to program the lighting system to turn on/off specific lights at specific times, or to receive a notification that a specific light bulb or light is not working), an automobile ignition system (e.g., to send a command to start the automobile and turn on the heating system, or to receive a notification from the automobile/ignition system that the automobile will not start, or a malfunction was detected). These are merely some examples, and other devices may be used. According to an example implementation, each (or one or more) of these devices may include a processor or controller or processing logic, memory and network interface to allow the device to communicate to intermediary 116 and/or other computing devices.

Some illustrative example transports that may be supported by a client/client application or user account, or supported by a device may include: HyperText Transfer Protocol (HTTP), Secure Sockets Layer (SSL), one or more email protocols, Ethernet, Transmission Control Protocol/Internet Protocol (TCP/IP), Short Message Service (SMS) or other texting service, one or more social media applications or social media messaging applications and their associated protocols, a Cloud Messaging protocol (GCM), Extensible Messaging and Presence Protocol (XMPP), Bluetooth wireless protocol/standard, Long Term Evolution (LTE) or other cellular communications protocol, IEEE 802.11/Wireless LAN (WLAN) technology and communications protocol, or other transport. These are merely a few example transports, and others may be used.

Therefore, a user (associated with a user account) may be interested in using his client computer 110/client application(s) 112 to control one or more devices and/or receive information/notifications from one or more of the devices. However, each of a plurality of devices may support a transport (e.g., channel, communications technology or communications protocol) that is not necessarily supported by client computer 110/client application 112. Therefore, intermediary 116 may operate as a multiple-transport go-between or interface between clients and registered devices, e.g., by receiving information (e.g., commands/notifications) from a source device/application via a first transport (that is supported by the source), and then forwarding the received information to a target device/application via a second transport (that is supported by the target).

As shown in the example of FIG. 1, some illustrative example devices may include device 1 (e.g., a printer, supporting a device-supported transport of TCP/IP), device 2 (e.g., an alarm system, supporting GCM), device 3 (e.g., a HVAC system supporting XMPP), device 4 (e.g., a camera supporting Bluetooth), . . . and a device N (e.g., supporting WLAN). These are merely some examples, and many other types of devices and transports may be used.

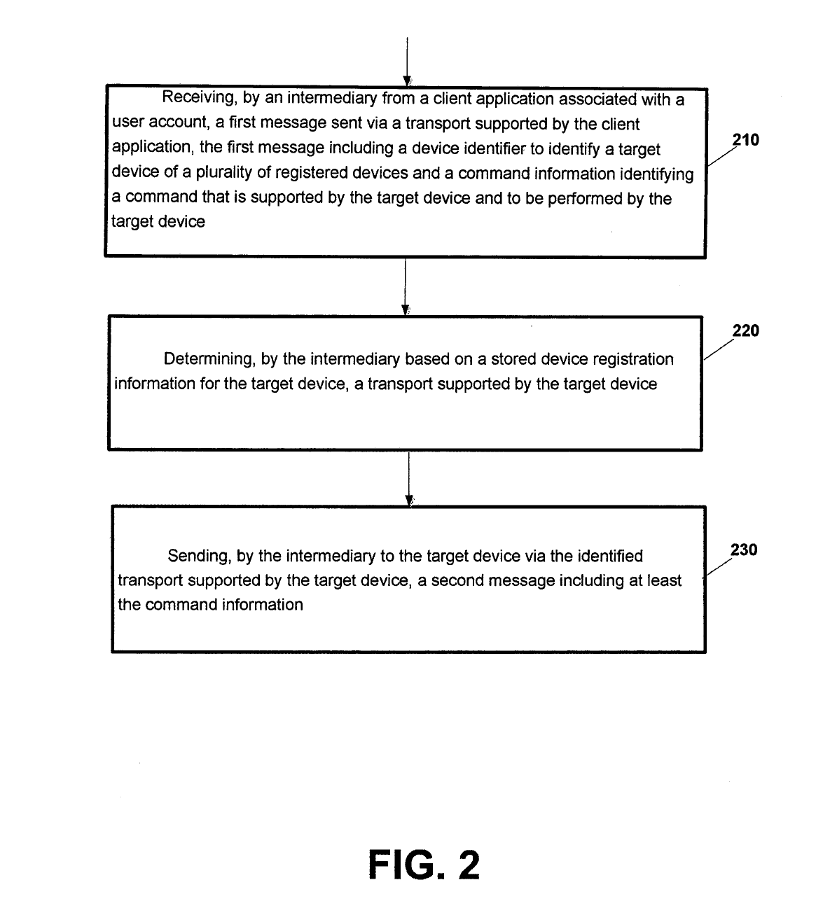

FIG. 2 is a flow chart illustrating operation of an intermediary 116 in which a command is received from a client application and forwarded to a device according to an example implementation. Operation 210 includes receiving, by an intermediary from a client application associated with a user account, a first message sent via a transport supported by the client application, the first message including a device identifier to identify a target device of a plurality of registered devices and a command information identifying a command that is supported by the target device and to be performed by the target device. Operation 220 includes determining, by the intermediary based on a stored device registration information for the target device, a transport supported by the target device. And, operation 230 includes sending, by the intermediary to the target device via the identified transport supported by the target device, a second message including at least the command information.

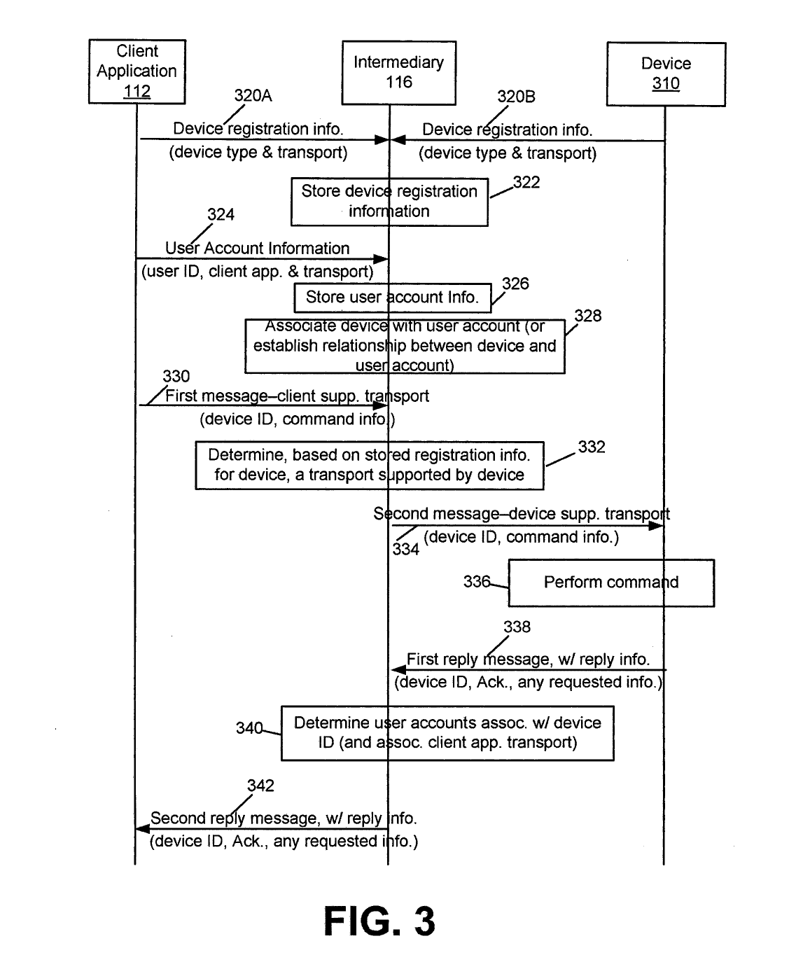

FIG. 3 is a diagram illustrating operation of an intermediary according to an example implementation. In the example shown in FIG. 3, an intermediary 116 is in communication with a client application 112 and a device 310.

At 320 (320A or 320B), intermediary 116 may receive device registration information for one or more devices. Two alternative techniques (shown by 320A and 320B, FIG. 3) may be used to communicate device registration information to intermediary 116. At 320B, a device 310 may send a message(s), including the device registration information, to intermediary 116 to register the device. Or, alternatively, at 320A, a user may log in to intermediary 116, for example, by using a username and password for the user account, e.g., via client application 112. Once logged in to intermediary 116, the user of the user account may register one or more devices with intermediary 116, which may include sending (e.g., via HTTP Post operation from client application 112) device registration information for one or more devices to intermediary 116 for storage. At 322, intermediary 116 stores the received device registration information for the device in a database, such as in device registration database 118 (FIG. 1).

According to an illustrative example implementation, device registration may include intermediary 116 receiving and storing device registration information for a device. The device registration information received to register a device may include, for example: 1) a device description, including, for example, a device type (e.g., printer, oven, automobile, camera), a device identifier (e.g., a device ID or other identification information for the device), an icon to be used to represent the device on a display or interface, 2) a set of commands supported by the device, and 3) one or more transports supported by the device. Other information may be included as well. Alternatively, intermediary 116 (e.g., upon receiving device registration information) may assign a unique device identifier (device ID) to a device. Although not shown in FIG. 3, the intermediary 116 may send a reply or acknowledgement to the registering device or registering user account/client application that confirms that the device has been registered and identifies the device identifier or device ID for the registered device.

If a device is registered via or by a user account with intermediary 116, this may, for example operate to associate the device with the user account or may establish a relationship between the user account and the registered device. For example, when a client application associated with a user account registers a user device with intermediary 116, an ownership relationship may be established between the user account and the device where the user account owns the device. In an example implementation, device ownership may allow the owning user account (or client applications associated therewith) to receive information or notifications from the device via intermediary 116, and allows the user account to send commands and other information to the device via intermediary 116 for example. Also, the registering (or owning) user account may also share access to the registered device to other user accounts to allow these other user accounts to receive notifications from such device and/or send commands to such device, via intermediary 116. For example, in sharing access of a device with another user account, the owning user account may set one or more rights or permissions for the device, e.g., permission to receive information or notifications from the device, permission to send commands to the device, permission to share device access with other user accounts, etc. In another example implementation, some devices may have a status of public access in which any user account/client application may receive notifications from and/or send commands to (via intermediary 116) the device.

At 324, intermediary 116 may receive user account information from a client application 112, e.g., via a HTTP Post operation from the client application 112 to intermediary 116.

At 326, intermediary 116 may store, in a database (such as device registration database 118), the user account information including, for example, a user (or user account) profile. In an example implementation, a user profile may include a user ID or other information identifying the user account, information identifying one or more client applications associated with the user account and a transport(s) supported (or used) by each client application for communicating with intermediary 116. Alternatively, for example, a user may log-in to intermediary 116 using the user's web services (e.g., email, documents or other cloud services) account login information (e.g., User ID and password) or social media account login information, and the profile (e.g., identifying client applications and client-supported transports) for the user/user account, which may be stored in a database outside of database 118, may then be accessed (or received) by intermediary 116 and stored in database 118.

According to another example implementation, a user account may use different transports and/or different client applications to send messages to intermediary 116 and to receive messages to intermediary 116. Thus, in an alternative implementation of 324 and 326, intermediary 116 may receive and store user account information including information identifying a first transport (e.g., HTTP) used by a first client application (e.g., a web browser) associated with the user account to send messages to the intermediary 116, and a second transport (e.g., SMS or texting protocol) used by a second client application (e.g., a texting or message application) associated with the user account to receive messages from the intermediary 116. For example, for a user account, the client application(s) and the supported transport(s) for sending messages to intermediary 116 may be the same as or may be different from the client application(s) and supported transport(s) for receiving messages from intermediary 116. Also, in another example implementation, a first client application 112 provided on a first client computer may be used to send messages via a first transport to intermediary 116, and a second client application 113 on a second client computer 111 may be used to receive messages via a second transport from intermediary 116.

At 328, after a user has logged in to intermediary 116 via a user account, a user may obtain or determine a device ID for one or more devices, and may link or associate one or more devices with the user account, or may establish a relationship (e.g., device ownership, or device access) between the user account and one or more devices. For example, once a device is associated with the user account (or a relationship has been established between a device and a user account), notifications from such owned or associated device may be forwarded by intermediary 116 to the user account (or to one or more client applications for the user account). Also, according to an example implementation, associating a device with a user account (or establishing a relationship between the user account and the device) may also allow commands to be sent from the user account (or client application associated with the user account) to the associated (or owned or accessed) device via intermediary 116.

At 330, intermediary 116 may receive from a client application associated with a user account, a first message sent via a transport supported by the client application. The first message may include, for example, a device identifier to identify a target device of a plurality of registered devices and a command information identifying a command that is supported by the target device and to be performed by the target device.

In one example implementation, intermediary 116 may be an intermediary 116A as a local application running on client computer 110. Intermediary 116A may, for example, include a library of functions that may be called by a client application 112. Thus, in an alternative example implementation, at 330, intermediary 116A may receive, from client application 112, a function call to forward a received command to a target device, where the function call may include, as parameters, the command and the device ID of the target device, for example. In yet another example implementation, intermediary 116 may be provided as intermediary 116B, which may be cloud-based intermediary service provided on a network or network server.

At 332, intermediary 116 may determine, based on a stored device registration information for the target device, a transport supported by the target device. For example, intermediary 116 may perform a lookup into device registration database 118 based on the device ID of the target device to retrieve the device profile (or device registration information) associated with the device ID of the target device. Once the profile or device registration information for the target device has been identified or retrieved, intermediary 116 may identify one or more transports supported by the target device. For example, one of the supported transports may have been selected for use at the time of registration (e.g., selected by registering device or by user/user account as a preferred transport to communicate with the target device (e.g., a first transport selected as a preferred or primary transport, and a second transport selected a secondary or backup transport). Or, intermediary 116 may select one of a plurality of transports supported by the target device for use in communicating with the target device (or for forwarding the command information to the target device). For example, intermediary 116 may select a first supported transport based on the first transport being currently available, and a second supported transport being unavailable or congested. Therefore, intermediary 116 may determine or select a transport supported by the target device based on the device registration information for the target device that is stored in the device registration database 118, for example. Therefore, a transport for a device may be selected in advance, e.g., at the time of device registration. Or, intermediary 116 may select one of a plurality of device-supported transports to use for communicating with the target device after receiving the message requesting a command or other information be forwarded to the target device.

At 334, the intermediary 116 may send to the target device 310, via the identified transport supported by the target device, a second message including at least the command information. In this manner, intermediary 116 may forward the received command information to the target device via a transport supported by the target device.

In an alternative implementation of 334, the command information may be sent from intermediary 116 to device 310 via the use of a plurality of (or multiple) messages. For example, intermediary 116 may send a notification, e.g., via a first device-supported transport, to the target device 310, where the notification may indicate that intermediary 116 has information to be sent to device 310. Intermediary 116 may send the command information (or at least a portion thereof) via a second message (and possibly via a second device-supported transport that is different than the first device-supported transport used by the notification) to the target device 310.

For example, in some cases, a device 310 may use a transport (such as HTTP, for example) in which a server or a server program (such as intermediary 116) may be unable to initiate a data transfer to a client application. In this example, the device 310 may be considered as a client application, and intermediary 116 may be a server program. In this case, a notification may be sent via a transport that supports server-initiated data transfers to a client or client device. Transports that allow a push notification from a server to a client (or server-initiated communication) may include XMPP and APNS (Apple Push Notification Service), and GCM, as examples. Then, the device 310, in response to receiving the notification of pending data for the device, may perform a HTTP Get operation to obtain the command information from intermediary 116. Alternatively, the command information may be sent via a transport that allows or supports server-initiated data transfers. In another example implementation, multiple messages may be used to send the command information from the intermediary 116 to device 310 where the command information is too large to be sent via a single message, for example.

At 336, in response to receiving the command, the target device 310 may perform the specified command, e.g., turn on a light, pre-heat the oven, start the automobile, print a document, take a picture, retrieve a requested file . . . . For example, if the target device is a storage device, the following command information (command and one or more parameters) may be sent from client application 112 to intermediary 116. Intermediary 116 may then forward this command information to the target device:

{
deviceID: ‘cbaf7327ca’,
name: ‘readfile’,
parameters: {path: ‘/usr/local/datafiles/file5678’ }}

In this example noted above, command information, including a command ‘readfile’ is sent by intermediary 116 to a storage device having a device ID of ‘cbaf7327ca’. The command information also includes a parameter that specifies a path or location of the file that is being requested to be read by the storage device and returned to the client application 112. Thus, in response to receiving the above command information, the storage device may read or retrieve a copy of the requested file.

At 338, target device 310 may also send, a first reply message to intermediary 116 via a transport supported by device 310. The first reply message may include reply information, such as confirming or acknowledging performance of the specified command, indicate a status of the device (e.g., printer offline, camera not operating), or a status of the performance of the command (e.g., performed, performance attempted but malfunction occurred), etc. Also, the reply information in the first reply message at 338 may include any files or any other information that was requested by the command. For example, if a file was requested, the file may be sent at 338, e.g., via one or more messages, via a device-supported transport to intermediary 116. As another example, a command of ‘storage.list’ may be sent to a storage device along with a path name. The device may retrieve a list of files, and attach or include this requested list of files (found by the device at the specified path) in the first reply message, at 338, for example.

At 340, intermediary 116 may receive the first reply message from device 310 via a device-supported transport, and may determine a user account associated with the transmitting (or source) device 310, or determine a user account that has a relationship with the transmitting device 310. The first reply message at 338 may, for example, also include a device ID for the transmitting device, or a user account ID or other information identifying a user account, or a transaction ID. Intermediary 116 may, for example, include a transaction ID within the second message sent to device 310 at 334, and when a reply message from device 310 includes this transaction ID that is returned to intermediary 116, the transaction ID may be used by intermediary 116 to identify an associated user account, e.g., in the event there may be multiple user accounts that are associated (or have a relationship) with this device.

At 342, intermediary 116 may send a second reply message to a client application associated with the user account (or to client applications associated with each of multiple user accounts), and via a transport supported by the client application. The second reply message may, for example, include (or forward) the reply information received via the first reply message, including, e.g., an acknowledgement that the command was performed, any device status, and any requested information or files, for example. Thus, for example, intermediary 116 may extract the reply information received via the first reply message at 338, and provide or encapsulate the extracted reply information in the second reply message at 342 that is sent to a client application 112 associated with the user account.

In addition to commands (which may instruct a device to perform some action), a client application may send information to a device via intermediary 116. For example, a client may send a notification to a device indicating that access control rules have been modified, and that a new user account (and associated client applications) may have access to the device. A notification in general may convey information, but typically does not include a command to perform some action.

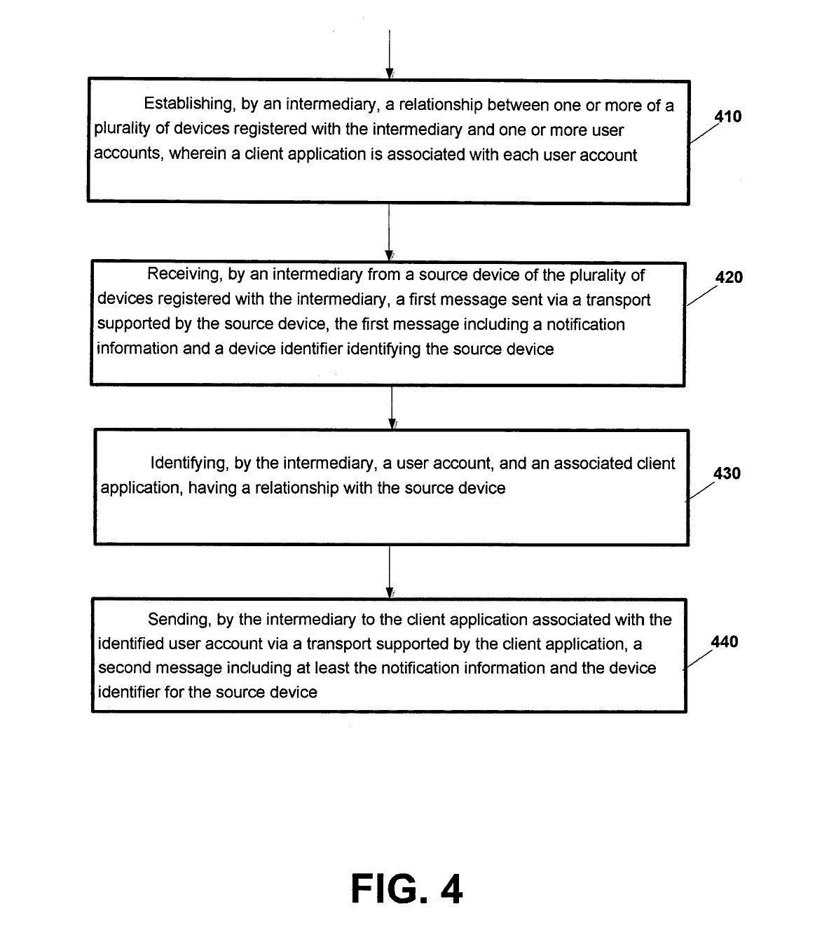

FIG. 4 is a flow chart illustrating operation of an intermediary 116 in which information is received from a device and forwarded to a client application according to an example implementation. Operation 410 may include establishing, by an intermediary, a relationship between one or more of a plurality of devices registered with the intermediary and one or more user accounts, wherein a client application is associated with each user account. Operation 420 may include receiving, by an intermediary from a source device of the plurality of devices registered with the intermediary, a first message sent via a transport supported by the source device, the first message including a notification information and a device identifier identifying the source device. Operation 430 may include identifying, by the intermediary, a user account, and an associated client application, having a relationship with the source device. And, operation 440 may include sending, by the intermediary to the client application associated with the identified user account via a transport supported by the client application, a second message including at least the notification information and the device identifier for the source device.

Techniques have been described above in FIG. 3 for the intermediary 116 to receive a command from a user account or client application via a first message, identify a transport supported by a target device, and then forward the command in a second message to the target device via the transport supported by the target device. Similar techniques may be used by intermediary 116 to receive a notification from a source device 310 via a device-supported transport, and forward the notification to a client application 112 via a transport supported by the client application.

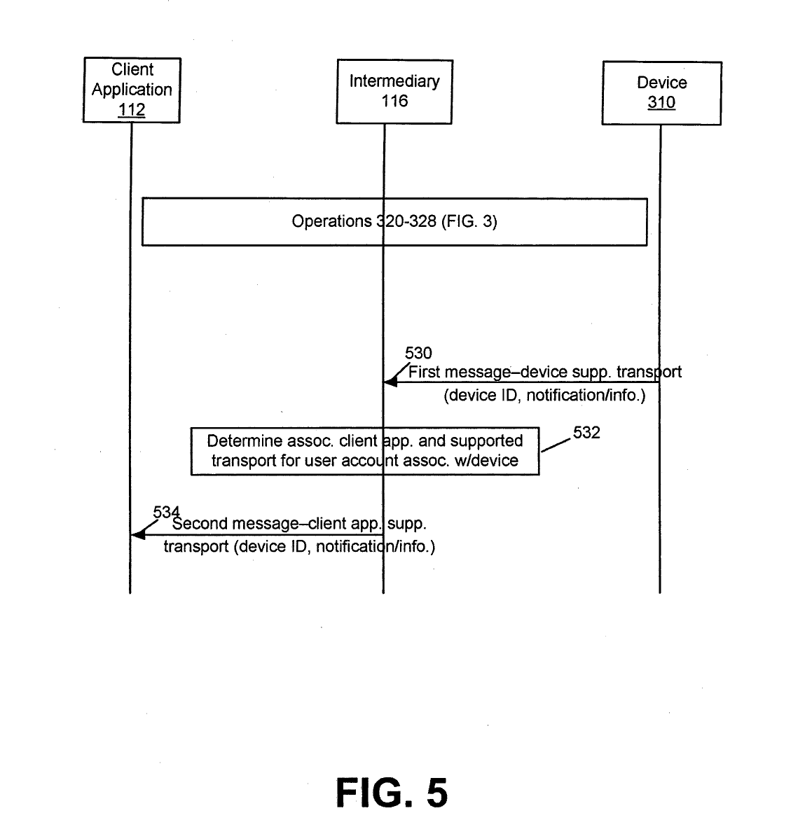

FIG. 5 is a diagram illustrating operation of an intermediary according to another example implementation. In FIG. 5, intermediary 116 may be in communication with a client application 312 and a device 310. Also, in FIG. 5, operations 320 (320A and/or 320B)—328 may be performed, as shown in detail in FIG. 3.

At 530, intermediary 116 may receive a first message sent from a source device 310, including a device ID and a notification or other information. The first message at 530 may also include a target user account ID, for example, to identify a target user account or destination for the notification. However, a user account ID may not be required within the first message to identify a destination user account(s), since intermediary 116 may store, or have access to, information identifying an association or relationship between the source device 310 and one or more user accounts.

Therefore, at 532, intermediary 116 may determine a user account(s) associated with (or having a relationship with) the source user device 310, and may identify a client application and supported transport associated with each of the user account(s). For example, intermediary 116 may use the target user account ID in the received first message, because this field, if present, identifies a user account that is the destination for the contents of the first message (e.g., the notification). Or, in the absence of such a target user account ID field within the first message, intermediary 116 may use stored relationship information, e.g., stored information (e.g., user account profile information and/or device registration information within database 118) to identify an association or relationship between source device and one or more user accounts. Intermediary may also identify a client application and supported transport associated with each identified user account.

At 534, intermediary 116 may send a second message, including the notification and device ID received via the first message at 530, to a client application 112 associated with (each of) the identified user account(s), via a transport supported by the client application.

A notification may communicate a variety of information to a user account or client application, depending on the type of device. For example, an oven may send a message notifying a client application user account that a timer has expired, or a notification may be sent from a HVAC system to a client application indicating that the air filter needs to be replaced or other service should be performed, or an alarm system may send a notification to an alarm monitoring application indicating that a window has been broken at a home or residence, etc.

According to an example implementation, although each device may support or implement different commands, the commands and notifications may be provided or communicated between intermediary 116 and client applications and devices in a standardized text format. For example, the commands and/or notifications sent between user accounts/client applications and registered devices via intermediary 116 may be provide in Javascript Object Notation (JSON), Extensible Markup Language (XML) or other standardized text format. For example, the commands and/or notifications may be provided as a JSON-encoded command or notification. For example, a command or notification may be provided using an attribute:value pair in accordance with JSON.

Below is an example of a notification sent from a source device to a user account or client/client application.

{
deviceID: ‘cbaf7327ca',
deviceKind: ‘smokedetector',
timestamp: ‘26536141231
severity: ‘high', //may be ‘low' if its not important data
data: {
smokelevel: 56,
activefor: 60000, //10 minutes already
}
}

In this example, a device (or type/kind ‘smokedetector’) is providing a notification of a detected smoke level that is ‘high’, and also indicates an amount of time that this smoke level has been active for (e.g., active for 10 minutes). The fields in this example notification may be specific to this device or at least specific to this type of device/devicekind (smokedetector).

In one example implementation, intermediary 116 may generate a message for the user account or client application based on one or more fields in the received notification, and may forward the message to the user account. For example, the intermediary 116 may compare the smokelevel:56 to one or more thresholds, and may add additional text or information to the notification, such as providing an indication that “Warning—smoke level is too high, please evacuate,” which may be displayed or output to the user account via one or more transports supported by the user account for example. Alternatively, it may be a client application (rather than the intermediary 116) that may receive the notification (and its various fields) related to the smoke detector status, compare the smokelevel to one or more thresholds, and may display the associated Warning text to a user, based on receipt by the client application of the smokelevel:56.

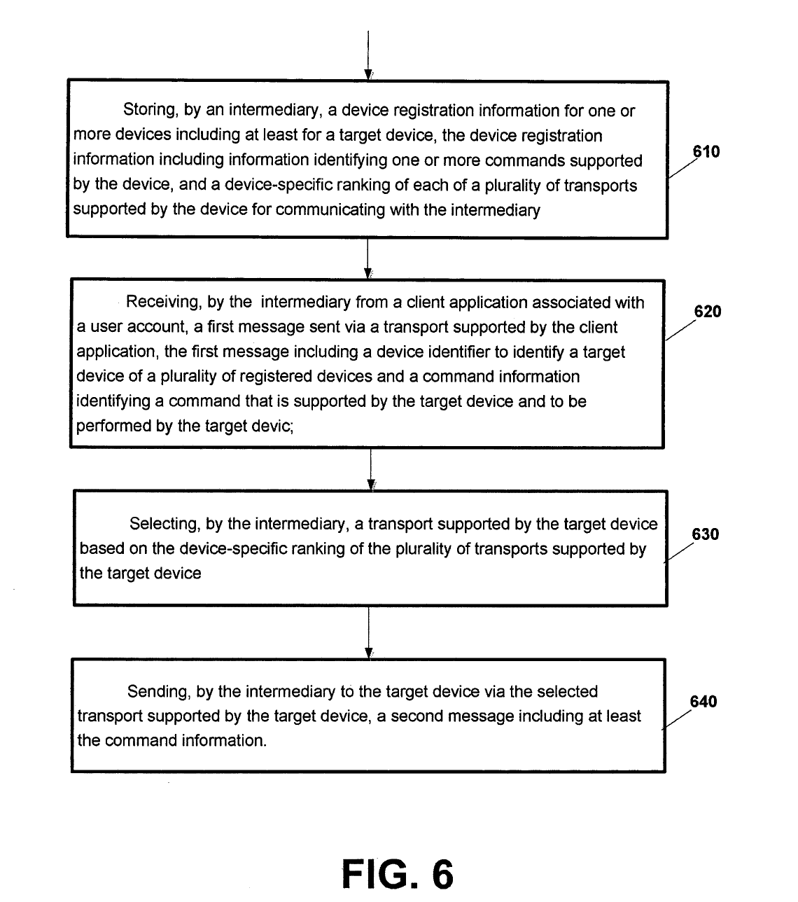

FIG. 6 is a flow chart illustrating operation of an intermediary according to an example implementation. Operation 610 includes storing, by an intermediary, a device registration information for one or more devices including at least for a target device, the device registration information including information identifying one or more commands supported by the device, and a device-specific ranking of each of a plurality of transports supported by the device for communicating with the intermediary. Operation 620 includes receiving, by the intermediary from a client application associated with a user account, a first message sent via a transport supported by the client application, the first message including a device identifier to identify a target device of a plurality of registered devices and a command information identifying a command that is supported by the target device and to be performed by the target device. Operation 630 includes selecting, by the intermediary, a transport supported by the target device based on the device-specific ranking of the plurality of transports supported by the target device. And, operation 640 includes sending, by the intermediary to the target device via the selected transport supported by the target device, a second message including at least the command information.

According to an example implementation, a device may support a plurality of different transports. Various criteria may be used by intermediary 116 to select one of a plurality of device-supported transports for communicating with a device. According to an example implementation, a device-specific initial ranking of transports may be received and stored by intermediary 116. Intermediary 116 may also adjust or update the ranking of transports for a device based on, for example, information received from a client application, information received from one or more devices regarding one or more of the transports, and/or characteristics of a received message, payload or command information to be sent to a device, or other criteria. When a message is received that includes a command information or other information to be forwarded to a device, intermediary 116 may select one of the plurality of device-supported transports based on the (e.g., initial or adjusted) device-specific ranking of transports, e.g., to select the highest ranked transport or one of the highest ranked transports for the device.

The device-specific ranking of transports may be received and stored by the intermediary 116. Alternatively, a device-specific ranking of transports may be determined (created) by intermediary 116 based on, for example, a list of supported transports and features/performance characteristics of each transport, and one or more performance requests or requirements for the device, e.g., by identifying transports that have one or more characteristics that best fit or match the performance requests or feature requests for the device.

For example, at 322 (FIG. 3), the device registration information stored by intermediary 116 for a device (or for each of a plurality of devices) may include an initial device-specific ranking of each of a plurality of transports supported by the device. The device-specific ranking of transports may identify a ranking of transports that are supported by the device, e.g., from a highest ranked transport to a lowest ranked transport, where higher ranked transports (or a highest ranked transport) may typically be preferred for communication with the device. Thus, the device-specific ranking of transports may identify which (e.g., higher ranked) transport(s) are preferred or prioritized for communication with the device over other (e.g., lower ranked) transport(s). Because each device may be a different device type, may be provided at a different location, include different features or capabilities, perform different functions, include different hardware and/or software/firmware, etc., each device may include a different device-specific ranking of transports. For example, each device may be a different type of device, or a processor or processing system (processor, memory with software or firmware for execution, and a network interface) associated with (or controlling) a different type of device (e.g., printer, alarm system, camera, HVAC system, TV, automobile, lighting control system, and the like), and may be provided in a different location or may perform in different circumstances.

Therefore, each device may have different needs or desired characteristics for a transport that is selected for communication with the device. For example, some devices may require or need communication with a short latency or delay, while other devices can tolerate significant delays or latencies in communications between client application and the device. Likewise, some devices may typically receive (or send) message payloads, e.g., including command information (or other information) from a client application via intermediary 116 that are large in size (or greater than a threshold size), while other devices may always or typically send or receive message payloads that are smaller in size (or less than the threshold size). In another example, some devices (e.g., TVs, stereos, video cameras, music playing devices or applications) may request or benefit from transports that provide audio and/or video streaming.

In addition, the various transports may have different features or performance characteristics, e.g., related to: latency or delay, transport speed, delivery reliability guarantees (such as reliable delivery with acknowledgements and/or retransmissions), message payload size, usage statistics such as a number of successful deliveries and/or number of failed delivery attempts over a last X number of attempts (which may be referred to as a successful delivery rate for a transport) and other transport features (e.g., ability of a transport to provide audio and/video streaming or audio/video delivery). Some transports, such as email and SMS or messaging transports, may have a significantly longer delay or latency as compared to other transports (such as XMPP). Some transports, such as XMPP, may be unable to handle larger payload sizes, whereas HTTP (and other transports) may be able to handle payloads larger (or greater in size) than XMPP as an example. Also, some transports, such as Web Real-Time Communications (WebRTC) may require a significant delay (e.g., 5-20 seconds) to set up a session, but then may provide a higher data transfer rate (or data throughput) and/or may provide audio and/or video streaming capabilities.

In an example implementation, intermediary 116 may be required to use the highest ranked transport to communicate with (or send message to and/or receive messages from) a device. In another example implementation, the device-specific ranking of transports may be used merely as guidance or a suggestion to the intermediary 116 (e.g., where the intermediary may choose a highest ranked transport or may choose a lower ranked transport). In example implementations, device registration information, including, for example, a device-specific ranking of transports, may be provided via message sent from a device to the intermediary 116, or may be provided via a client application or from a client computer. According to an example implementation, intermediary 116 may select a transport for communicating with a device based on the (e.g., initial or adjusted/updated) device-specific ranking of the plurality of transports for the device.

According to another example implementation, an initial device-specific ranking of transports may be updated or adjusted based on various criteria or based on various information, such as based on information or feedback from the device or other devices (e.g., based on usage statistics for one or more transports that may indicate a number or percentage of successful deliveries or failed deliveries over such transport to the same device or to multiple devices). Also, the device-specific ranking of transports may be adjusted based on information (e.g., updated or adjusted device registration information) received from a client application, such as a client application associated with a user account that owns or controls the device. A device-specific ranking of transports may be adjusted or updated by a client application, by intermediary 116, or by the device.

Alternatively, the (e.g., initial) device-specific ranking of transports for a device may be updated or adjusted based on a characteristic(s) of a message or payload to be sent or forwarded to the device, as compared to the performance characteristics of the transports supported by the device. In this manner, a message-specific ranking of transports for a device may be generated by adjusting the device-specific ranking of transports. For example, a message-specific ranking of transports for a device may be used for selecting a transport to be used for sending/forwarding a payload of the message to the device. Thus, for example, the ranking of transports for a device may be adjusted based on a characteristic(s) of the message or payload (such as a characteristic of the command) to be sent or forwarded to the device, e.g., to increase a rank of a transport(s) that have performance characteristics that may more closely match the characteristics or requirements of the message or payload (or command) to be forwarded or sent to the device. For example, by adjusting the ranking of transports based on message or payload characteristics as compared to one or more performance characteristics of one or more transports, the intermediary may be more likely to select a transport to send or forward a message, payload or command information that provides performance or services that most closely match or meet the requirements of the message, payload or command information.

Therefore, according to an example implementation, an intermediary 116 may determine a characteristic of a first message received from a client application, adjust a device-specific ranking of a plurality of transports supported by the target device based on the determined characteristic, and select, by the intermediary 116, a transport supported by the target device based on the adjusted device-specific ranking of the plurality of transports. The payload and/or command information of the first message may then be forwarded or sent from the intermediary 116 via the selected transport. For example, adjusting the device-specific ranking of the plurality of transports for the device may include adjusting the device-specific ranking of the plurality of transports based on one or more of the following: a size of a payload of the first message (e.g., including command information) to be delivered to the target device, whether communication of the payload of the first message or performance of the command may involve or benefit from communication or streaming of audio and/or video signals, and/or any latency requirements for communication of the payload or command information to the target device.

According to another example implementation, intermediary 116 may adjust a device-specific ranking of transports based on a success rate in sending messages from the intermediary to one or more devices via one or more of the transports. For example, if 40% of the recent messages sent from the intermediary to one or more devices via a specific transport were not received by the target device(s) (a 60% success rate in sending messages for the specific transport), then the ranking of this specific transport may be decreased, e.g., from a first ranked transport to a fourth (or last) ranked transport for a device, since this specific transport may be considered to be unreliable. Also, intermediary 116 may adjust a device-specific ranking of transports based on a current availability of one or more of the transports. For example, it may be determined that a transport between intermediary 116 and one or more devices has not been working recently, e.g., due to network congestion, corruption of a protocol entity (or protocol stack) executed by the intermediary 116 or at one or more devices, or other problem with the transport, and a rank of such transport may be decreased. Therefore, intermediary 116 may receive feedback from one or more devices that report a failure to receive a message (such as a negative acknowledgement) via a transport or may receive feedback from one or more devices indicating that a transport is not working or is unavailable. For example, based on this feedback from one or more devices, intermediary 116 may adjust or update a ranking of transports for one or more devices, e.g., based on a success rate in sending messages via the transport and/or based on a current availability of such transport.

An illustrative example will now be briefly described in which a ranking of transports is determined and/or adusted/updated based on one or more criteria. All or part of this example approach may be used to perform an initial ranking of transports or to adjust or update the ranking of transports.

Prerequisites: initial device ranking and weighting of priorities:

1) Initial device weighting of transports: According to an example implementation, an initial weighting of transports for a device may be assigned. This initial weighting of transports may be provided in different forms, such as by assigning an initial score to each transport, such as, for example: XMPP—1, GCM—0.5, WebRTC—0.1. Or, it may be provided or determined as a priority list, without exact numbers or scores: XMPP, GCM, WebRTC.

2) Device weighting of priorities: According to an example implementation, a weighting of priorities for the device may be provided, such as, for example: Speed (latency)—1, reliability—0.5, (a larger weighting for speed/latency means that speed or latency is more important than reliability for the device). In an example implementation, the device, a client application, or intermediary 116 may assign or may provide these initial rankings or weightings (initial device weighting and weighting of priorities) to each transport during registration and/or may update this information later by communicating with intermediary 116. According to an example implementation, the following may occur when an example message of size 10 KB needs to be delivered from the intermediary 116 to a device:

1. Intermediary 116 assigns initial ranking to all transports available for device. Some examples:

a) Initially, set all transports to same rank, or to a same score of 1: XMPP=1, GCM=1, WebRTC=1; or

b) Assign initial transport rankings or initial transport scores according to the initial device weightings: XMPP—1, GCM—0.5, WebRTC—0.1.

2. Intermediary 116 adjusts or modifies the initial ranking of transportsdepending (or based) on one or more of the following criteria (by way of example):

a) latency characteristics of the transport, such as a delay or latency in sending or delivering messages;

b) previous usage statistics of using the transport (for the particular device and/or overall in history of service or over time period), such as a message delivery success rate or message delivery failure rate for transport for one or more devices;

c) throughput characteristics of transport, which may include, e.g., an average or instantaneous data rate or bandwidth for the transport;

d) reliability characteristics for transport, such as whether transport provides reliable message delivery, e.g., through use of acknowledgements, retransmissions or other reliability technique;

e) features available for transport, such as whether transport provides features, such as, for example, audio streaming, video streaming, etc. Also, a feature of the transport such as the maximum payload size or message size that can be accommodated or communicated via the transport;

f) session initialization delay for the transport, which may include the delay or latency for a communication session to be set up or established between two protocol entities for the transport, e.g., at the device and the intermediary; and/or

g) current availability of the transport.

Here is an illustrative example, where various transport characteristics are taken into account when modifying or adjusting a ranking of transports for a device.

a) In this illustrative example, XMPP may have the lowest latency, and therefore, receives a multiplier of 1.2; WebRTC has a medium latency and therefore, receives a multiplier of 0.8; and GCM may have slightly greater latency and receives a multiplier of 0.7, for example.

If an initial ranking of transports uses the initial device weighting of transports, then the adjusted ranking (scores) of transports, where a highest score indicates a highest ranked or most preferred transport, may be determined as follows: XMPP=1.2, GCM=0.7*0.5, WebRTC=0.8*0.1

b) previous usage statistics. In this illustrative example, it is know that today, GCM is not working (or not working well), so a 0.5 multiplier is applied to GCM, and a 1 is applied as a multiplier for the other transports, which are working. The resulting scores or rankings, as updated based on latency and usage statistics, may be as follows:

XMPP=1.2, GCM=0.7*0.5*0.5, WebRTC=0.8*0.1

c) In this example, message is 10 KB in size; But all transports are fine with transferring 10 KB messages or payloads, so all receive a multiplier=1. Therefore, the scores or adjusted or updated rankings, e.g., taking into account latency, usage or failure statistics, and message or payload size, may be determined as follows:

XMPP=1.2, GCM=0.7*0.5*0.5, WebRTC=0.8*0.1

d) reliability: XMPP is less reliable, GCM may have medium reliability, and, WebRTC may be most reliable. Therefore, the following realibility multipliers may be applied or assigned: WebRTC=1, XMPP=0.5 and GCM=0.8

The adjusted or updated scores or transport rankings may be determined as: XMPP=1.2*0.5, GCM=0.7*0.5*0.5*0.8, WebRTC=1

e) Message is ordinary text data, not a video or audio, so WebRTC features are not considered, every transport receives multiplier=1:

In this example, the following adjusted or updated scores or transport rankings may result (no change since all received a multiplier of 1): XMPP=1.2*0.5, GCM=0.7*0.5*0.5*0.8, WebRTC=1.

f) Session initialization latency/delay: XMPP session and GCM session initialization are costless (negligible delay), but WebRTC has a penalty here of several seconds, so it gets multiplier=0.2. The resulting updated scores or transport rankings may be determined as: XMPP=1.2*0.5, GCM=0.7*0.5*0.5*0.8, WebRTC=0.2

g) transport availability: Unfortunately, XMPP is offline (it receives a multiplier=0), so this may result in an updated scores or transport ranking as follows, where the choice may be between WebRTC and GCM:

XMPP=1.2*0.5*0, GCM=0.7*0.5*0.5*0.8, WebRTC=0.2

Calculating all these:

XMPP=0, GCM=0.14, WebRTC=0.2

So, in this illustrative example, WebRTC may be selected as a transport to communicate with the device, e.g., since WebRTC may have a highest transport ranking. GCM is very close in score, so it could be chosen as well, in this example. One or more of these transport characteristics may be used to adjust transport rankings.

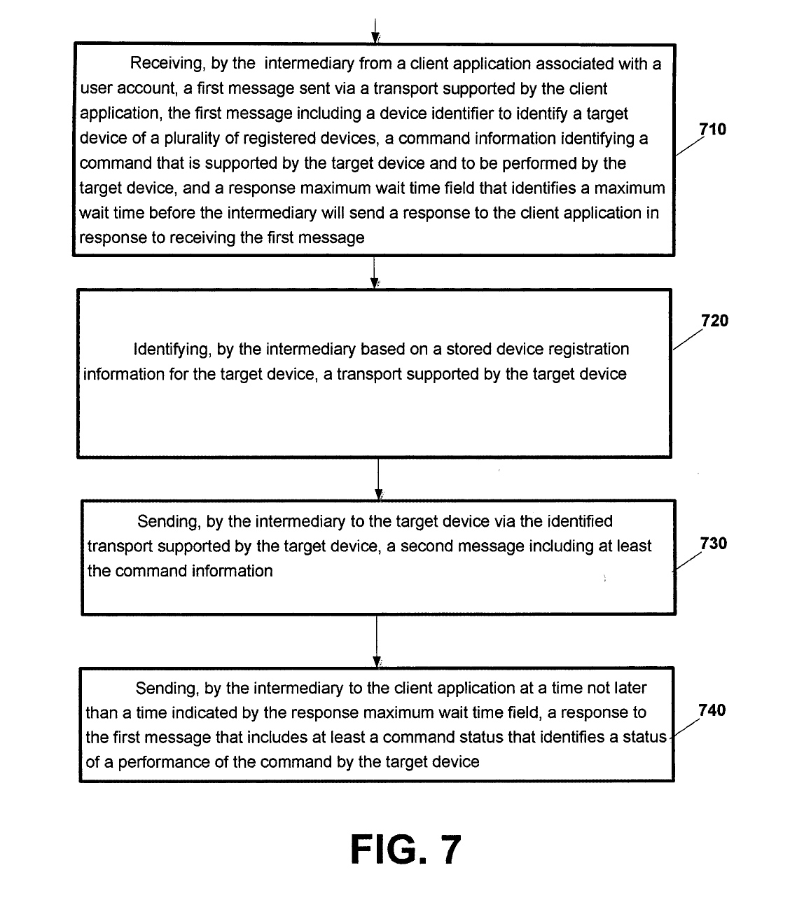

FIG. 7 is a flow chart illustrating operation of an intermediary according to another example implementation. Operation 710 may include receiving, by the intermediary from a client application associated with a user account, a first message sent via a transport supported by the client application, the first message including a device identifier to identify a target device of a plurality of registered devices, a command information identifying a command that is supported by the target device and to be performed by the target device, and a response maximum wait time field that identifies a maximum wait time before the intermediary will send a response to the client application in response to receiving the first message. Operation 720 may include identifying, by the intermediary based on a stored device registration information for the target device, a transport supported by the target device. Operation 730 may include sending, by the intermediary to the target device via the identified transport supported by the target device, a second message including at least the command information. And, operation 740 may include sending, by the intermediary to the client application at a time not later than a time indicated by the response maximum wait time field, a response to the first message that includes at least a command status that identifies a status of a performance of the command by the target device.

As described above with reference to the flow chart of FIG. 7, an intermediary 116 may receive a first message (e.g., which may be a HTTP request or other message) from a client application 112. The first message may include information, such as a command, to be sent to a target device, and a response maximum wait time (or response wait time field) that identifies a maximum wait time that the intermediary 116 will wait before sending a reply or response back to the client application 112. For example, the response maximum wait time may be set to a value that may be sufficient time for intermediary 116 to forward the command to the target device and for intermediary 116 to receive a command result and forward the command result back to the client application 112.

According to an example implementation, intermediary 116 may send to the client application 112, e.g., at a time not later than a time indicated by the response maximum wait time field in the first message, a response (or reply) to the first message. The response to the first message may include at least a command status that identifies a status of a performance of the command by the target device. For example, a command status may be one of a plurality of status values, such as a command received status that indicates that the command has been received (e.g., by the intermediary or by the target device), but has not yet been performed (or completed) by the target device. As another example, a command status may be provided in a response that is a command performed status indicating that the target device has performed the command. These are just two example command statuses, and others may be used.

In one example implementation, a short response maximum wait time may be indicated by the client application in the response maximum wait time field of the first message, e.g., a response maximum wait time may be set to zero or other low value to prompt an immediate response from the intermediary 116. For example, receiving a first message with a very short response maximum wait time (e.g., set to zero) may cause the intermediary 116 to immediately send a response back to client application 112 after intermediary 116 receives the first message. The response maximum wait time may be set to a longer value to allow the intermediary to wait up to a longer period of time before sending a response to client application 112.

In the case of a very short or even a zero maximum response wait time, the target device will typically not have sufficient time to perform the command provided via the first message (and in some cases, the target device may not have yet received the command) before the end (or expiration) of the response maximum wait time. Therefore, in this case, intermediary 116 may typically determine (at or before the end of the response maximum wait time) that a response has not been received by the intermediary 116 from the target device indicating a status of performane of the command, and intermediary 116 may then send a response back to the client application 112 indicating a command received status indicating that the command has been received but not yet performed by the target device.

Therefore, according to an example implementation, intermediary 116 may send a response to client application 112, either at the end or just before the end (or expiration) of the response maximum wait time specified in the received first message if no response has been received by the intermediary 116 from the target device indicating that the command has been performed, or at any time before such end (or expiration) of the response maximum wait time where the intermediary 116 receives a response from the target device, e.g., indicating that the target device has performed the command. In the first case, where no response (e.g., indicating that target device has performed the command) has been received by intermediary 116 from target device before end of the response maximum wait time, the intermediary 116 may send a response with a command received status indicating that the command was received but not yet performed. In the second case, where a response (e.g., including a command result) has been received by intermediary 116 from a target device before end of the response maximum wait time, the intermediary 116 may send a response to the client application 112 including the command result and a status of, e.g., command performed status indicating that the target device has performed the command.

In the event that intermediary 116 does not receive a response from the target device before end or expiration of the response maximum wait time, causing the intermediary to send a response to the client application 112 with a command received status, the client application 112 may later send a subsequent message or request to the intermediary 116 requesting a command status and/or command result for the command. Thus, for example, the first message sent from the client application 112 to intermediary 116 that includes, e.g., the command information, device identifier and response maximum wait time may be sent via a HTTP Post method to intermediary 116, and the response from intermediary 116 to the first message may be a HTTP response to this post method providing the command status (e.g., command received status). The third message, for example, may be provided as a HTTP Get method sent to intermediary 116 requesting the command status and command result for the command sent via the first message.

In an example implementation, with respect to the flow chart of FIG. 7, the response sent from intermediary to client application in response to the first message may be a first response indicating that the command has been received but not yet performed by the target device. The method may further include receiving, by the intermediary from the client application after a time indicated by the response maximum wait time field, a third message requesting a command result from the target device performing the command, receiving, by the intermediary from the target device at a time after a time indicated by the response maximum wait time field, a second response indicating that the command was performed and including a command result, and sending, by the intermediary to the client application, a third response including a command status indicating that the command has been performed by the target device and including the command result.

In the method of the flow chart of FIG. 7, the sending, by the intermediary to the client application at a time not later than a time indicated by the response maximum wait time field, a response to the first message may include: receiving, by the intermediary from the target device at a time before a time indicated by the response maximum wait time field, a first response indicating that the command was performed and including a command result, and sending, by the intermediary to the client application at a time not later than the time indicated by the response maximum wait time field, a second response including a command status indicating that the command has been performed by the target device and including the command result.

According to an example implementation, client application 112 may send the following message via HTTP Post method to intermediary 116, to be forwarded to a target device:

```
{
  name: 'storage.list',
  parameters: {
    path: '/tmp'
  },
  deviceId: '431e7608-95c3-1488-9532-a13c710cec90'
  response-max-wait-time: 10 seconds
}″
```

In this example first message, a command information is provided including a command name of storage.list that requests the identified target device (identified by the deviceID parameter) to return a list of files at the identified path ‘/tmp/. Client application 112 also includes a response-max-wait-time of 10 seconds. The response-max-wait-time parameter may be provided in a JSON message body, or as a HTTP parameter, for example. The intermediary 116 may then send a second message to the target device, e.g., including the command information (command name, path and any other command parameters), and deviceID parameter that identifies the target device.

In this example, intermediary 116 does not respond back to client application 112 immediately, but will wait up to a response-max-wait-time of 10 seconds for a response from the target device, before sending a response to the client application 112. In this example, the target device receives the command information, performs or executes the command, and returns the command results to the intermediary 116.

Here is an example detailed timeline.

1. Client application 112 sends an HTTP request with the command information, target device ID, and other parameters, to the intermediary 116. Client application 112 waits for the response.

2. Intermediary 116 sends a second message to the target device with the command information.

3. Target device receives the second message including the command information and performs or executes the command to obtain the results of the command. In this example, the command results may be a list of files found on the target device at the identified path location.

4. Target device sends a response to intermediary 116 with the command results by sending an HTTP request to intermediary 116, for example.

5. Intermediary 116 responds immediately to the target device confirming that it received the command results.

6. A response to the first message is now sent by the intermediary 116 to the client application 112 in an HTTP response, e.g., which responds to the original HTTP request from the client application that provided the command information (operation 1 above). This response may be sent by intermediary 116 to client application 112 within, or shortly after, the end of the response-max-wait-time (e.g., 10 seconds after receipt of the first message/command from client application 112). This response may include, for example, a command performed status indicating that the target device has performed the command, and the command results (e.g., list of files).

According to an example implementation, from a perspective of the client application 112, there may appear to be only one HTTP request and one HTTP response that provides the command results, with the communication between intermediary 116 and target device being transparent to client application 112.

Intermediary 112 may send a response to client application 112 after receiving the command results from the target device. Below is an example response sent from the intermediary 112 to the client application 112 after receiving command results from the device:

```
  {
  “kind”: “clouddevices#command”,
  “command_id”: “00bda5ca-105f-661c-981b-
  b975030e2efc03651d14-
89a9-8762-8322-509570cbfec7”,
  “device_Id”: “00bda5ca-105f-661c-981b-b975030e2efc”,
  “name”: “storage.list”,
  “parameters”: {
    “path”: “/tmp”
  },
  “results”: {
        “name”: “file1”
        “name”: “file2”
      }
    ]
  },
  “command status”: “performed”,
  “creationTimeMs”: “1405504599865”,
  “expirationTimeMs”: “1408096599865”
  }
```

This example response that is sent from the intermediary 116 to client application 112 via a HTTP response includes a command ID, a deviceID, the command results (file1, file2), a command status of “performed”, a creation time (e.g., indicating when the intermediary received the command), and an expiration time (after such expiration time, the target device will not perform the requested command).

If the intermediary 116 has not received a response from the target device at or after an end or expiration of the response-max-wait-time (e.g., 10 seconds), then intermediary 116 may send the following response to the client application, e.g., via a HTTP response:

```
  {
  “kind”: “clouddevices#command”,
  “command_id”: “00bda5ca-105f-661c-981b-
  b975030e2efc03651d14-
89a9-8762-8322-509570cbfec7”,
  “deviceId”: “00bda5ca-105f-661c-981b-b975030e2efc”,
  “name”: “storage.list”,
  “parameters”: {
    “path”: “itmp”
  },
  “status”: “received”,
  “creationTimeMs”: “1405504599865”,
  “expirationTimeMs”: “1408096599865”
  }
```

In this example, the command status is received or queued, meaning that the command has been received and queued, and is waiting to be performed by the target device, and no command results are included (since they have not been received yet). As noted above, after receiving the above response indicating the command has been received but not yet performed, the client application 112 may subsequently send another HTTP request to intermediary 116 to obtain the command results.

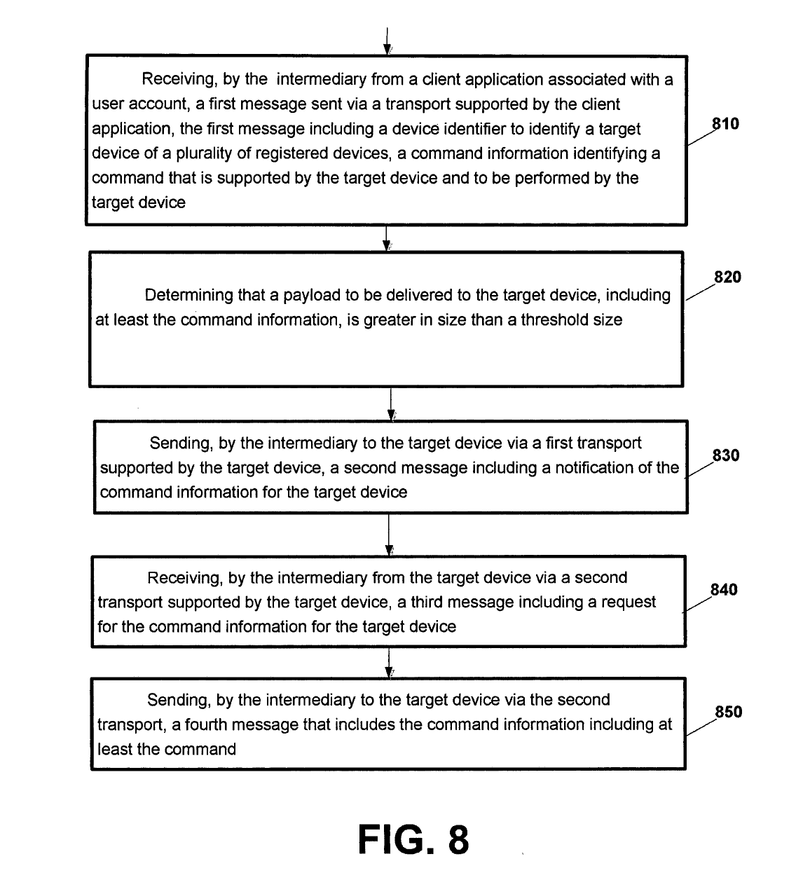

FIG. 8 is a flow chart illustrating operation of an intermediary according to another example implementation. Operation 810 may include receiving, by the intermediary from a client application associated with a user account, a first message sent via a transport supported by the client application, the first message including a device identifier to identify a target device of a plurality of registered devices, a command information identifying a command that is supported by the target device and to be performed by the target device. Operation 820 may include determining that a payload to be delivered to the target device, including at least the command information, is greater in size than a threshold size. Operation 830 may include sending, by the intermediary to the target device via a first transport supported by the target device, a second message including a notification of the command information for the target device. Operation 840 may include receiving, by the intermediary from the target device via a second transport supported by the target device, a third message including a request for the command information for the target device. Operation 850 may include sending, by the intermediary to the target device via the second transport, a fourth message that includes the command information including at least the command.

In the method illustrated in FIG. 8, the fourth message may include at least the device identifier that identifies the target device and the command information that includes a command name that identifies the command and a command identifier associated with the command information. Also, in an example implementation, the command information may further include a command creation time that identifies when the intermediary 116 received the command from the client application 112, and an expiration time that identifies a time when the command expires after which the target device should not perform the command if not already performed.

In the method illustrated in FIG. 8, the first transport supported by the target device supports at least a push-based communications that allows the intermediary to initiate a data transfer to the target device, and wherein the second transport supported by the target device supports at least a pull-based communications that allows the target device to initiate data communications with the intermediary. Also, for example, the first transport may be unable to deliver payloads that are larger than the threshold size. Also, in an example implementation, the third message may include a request for the command information for the target device, the request including at least a command identifier associated with the command information and the device identifier to identify the target device.

According to an example implementation, some transports, such as XMPP (as an example), may be unable to send or handle sending payloads larger than a certain size (or threshold size), whereas other transports, such as HTTP, may be able to handle communicating larger payloads or message sizes. In addition, some transports, such as HTTP may be considered to support only pull-based communications between a client and server, where pull-based communications may refer to a client or device obtaining information from a server or intermediary by sending a request to the server/intermediary to obtain the information. Thus, in pull-based communications, a server/intermediary may typically send a message or information only in response to a request from the client or device. For example, HTTP may typically only allow pull-based communications, and does not support push-based communications between client and server. Other transports, such as XMPP, may support both pull-based communications and push-based communications, where push-based communications may refer to the server/intermediary 116 being able to send or initiate a sending of a message or data transfer to a client or device (without first receiving a request from the device or client). Thus, for example, push-based communications may allow a server (such as intermediary 116) to initiate communications with a client (such as a client application or device), e.g., allowing the server to push data to the client/device. Whereas, pull-based communications may allow a client or device to initiate communications with a server/intermediary 116, e.g., allowing the client or device to pull data from the server/intermediary.

Therefore, according to an example implementation, intermediary 116 may determine that a message or payload (including command information) to be sent to a device is greater than a threshold. After it is determined that a payload to be delivered to a target device is greater than a threshold, the intermediary 116 may send a notification to the target device via a first transport supported by the target device indicating information to be delivered to the target device, e.g., where the first transport (e.g., XMPP) may be unable to send payloads greater than the threshold. However, in an example implementation, the first transport, for example, may support push-based communications, allowing the intermediary 116 to send the notification to the target device without being prompted or requested to do so by the device. The notification may also identify a second transport (e.g., HTTP) to be used by the target device to receive the information/payload from intermediary 116. For example, the second transport may be able to send or handle payloads or message sizes greater than the threshold size. Also, the second transport may support pull-based communications, allowing the target device to send a request, e.g., a HTTP Get method or HTTP request, to intermediary 116, in order for the target device to receive the command information from the intermediary 116 via a HTTP response.

The following example illustrates the process of sending a notification to the target device via a first transport, and then sending the payload, including the command information, via a second transport. Therefore, if the payload or message size is too large, e.g., is greater than a threshold, then intermediary 116 may send the following notification via a first transport (e.g. via XMPP):

```
  {
    “type”: “COMMAND_CREATED”,
    “deviceId”: “00bda5ca-105f-661c-981b-b975030e2efc”,
      “commandId”: “00bda5ca-105f-661c-981b-
      b975030e2efc03651d14-
89a9-8762-8322-509570cbfec7”
  }
```

In this example, the command information and/or other parameters may be omitted as they would make the notification too large for the first transport to handle.

Next, the target device may send a request (e.g., HTTP request) to the intermediary 116 via a second transport, e.g., via HTTP, to retrieve the payload or command information. Thus, in this illustrative example, the first transport may serve a purpose of allowing push-based communications for the notification, and the second transport serves a purpose of allowing the communication of larger payloads or message sizes.

In response to the HTTP request from the target device via the second transport, the intermediary 116 may then return a message to the target device including the full command information in the response/message, such as for example:

```
{
“command Id”: “00bda5ca-105f-661c-981b-b975030e2efc03651d14-
89a9-8762-8322-509570cbfec7”,
  “deviceId”: “00bda5ca-105f-661c-981b-b975030e2efc”,
  “name”: “storage.list”,
  “parameters”: {
    “path”: “Amp”
  },
  “status”: “received”,
  “creationTimeMs”: “1405504599865”,
  “expirationTimeMs”: “1408096599865”
}
```

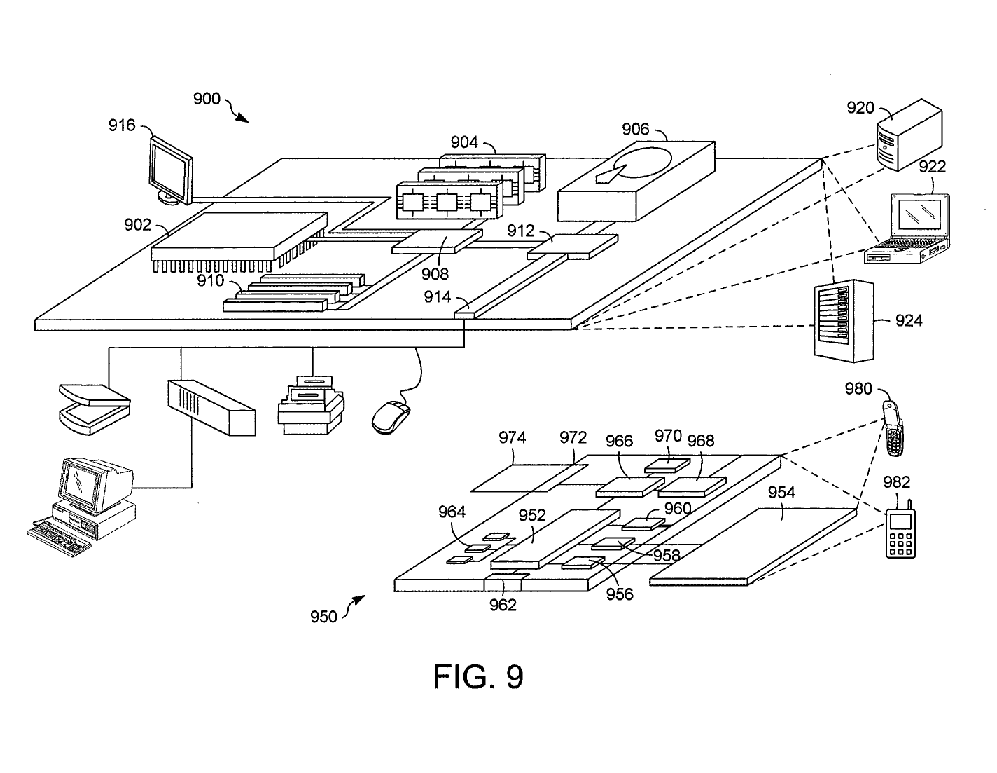

FIG. 9 shows an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 600. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provided in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, Wi-Fi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A computer-implemented method for executing instructions stored on a non-transitory computer-readable storage medium, the method comprising:
storing, by an intermediary, a device registration information for one or more devices including at least for a target device, the device registration information including information identifying one or more commands supported by the device, and a device-specific ranking of each of a plurality of transports supported by the device for communicating with the intermediary;
receiving, by the intermediary from a client application associated with a user account, a first message sent via a transport supported by the client application, the first message including a device identifier to identify a target device of a plurality of registered devices and a command information identifying a command that is supported by the target device and to be performed by the target device;
selecting, by the intermediary, a transport supported by the target device based on the device-specific ranking of the plurality of transports supported by the target device; and
sending, by the intermediary to the target device via the selected transport supported by the target device, a second message including at least the command information.

2. The method of claim 1 and further comprising:
storing, by the intermediary, user account information for the user account, the user account information including at least information identifying one or more transports supported by the client application for communicating with the intermediary including information identifying a first transport used by a first client application associated with the user account to send messages to the intermediary, and a second transport used by a second client application associated with the user account to receive messages from the intermediary, the first client application being different from the second client application.

3. The method of claim 1 wherein the receiving comprises:
receiving, by the intermediary from a first client application and via a first transport that are associated with the user account, the first message; and
wherein the method further comprises forwarding a notification received from the target device to a second client application and via a second transport that are associated with the user account, wherein the first client application and the second client application are different applications.

4. The method of claim 1 wherein the receiving comprises:
receiving, by the intermediary from a first client application running on a first client computing device and via a first transport that are associated with a user account, the first message; and
wherein the method further comprises forwarding, by the intermediary, a notification received from the target device to a second client application running on a second client computing device and via a second transport that are associated with the user account, wherein the first client application and the second client application are different applications, and wherein the first client computing device and the second client computing device are different computing devices.

5. The method of claim 1 and further comprising:
receiving, by the intermediary from the target device via the selected transport supported by the target device, a third message including a reply indicating that the command was performed by the target device; and
sending, by the intermediary to the client application, a fourth message including the reply.

6. The method of claim 1 and further comprising:
adjusting, by the intermediary, the device-specific ranking of the plurality of transports supported by the target device based on feedback provided by one or more of the devices to the intermediary.

7. The method of claim 1 and further comprising:
determining, by the intermediary, a characteristic of the first message;
adjusting the device-specific ranking of the plurality of transports supported by the target device based on the determined characteristic; and
wherein the selecting comprises selecting, by the intermediary, a transport supported by the target device based on the adjusted device-specific ranking of the plurality of transports.

8. The method of claim 7 wherein the adjusting comprises adjusting the device-specific ranking of the plurality of transports supported by the target device based on one or more of the following:
a size of a payload of the first message, including the command information, to be delivered to the target device;
whether communication of a payload of the first message, including the command information, to the target device involves communication of audio or video signals;
whether performance, by the target device, of the command involves communication of audio or video signals; and
any latency requirements for communication of the command information to the target device.

9. The method of claim 1 and further comprising:
adjusting the device-specific ranking of the plurality of transports supported by the target device based on one or more of the following:
a success rate in sending messages from the intermediary to one or more of the devices via one or more of the transports; and
current availability of one or more of the transports.

10. The method of claim 1 and further comprising:
determining that a size of the second message, including the command information, is greater than a threshold;
adjusting the device-specific ranking of the plurality of transports supported by the target device to favor one or more transports that are capable of handling messages greater than the threshold.

11. The method of claim 1 and further comprising:
determining that the command information is requesting audio or video data services;
adjusting the device-specific ranking of the plurality of transports supported by the target device to favor one or more transports that are capable of providing audio or video data delivery or streaming services.

12. The method of claim 1 wherein the transport supported by the client application comprises a communications protocol supported by the client application.

13. The method of claim 1 wherein the transport supported by the target device comprises a communications protocol supported by the target device.

14. A computer-implemented method for executing instructions stored on a non-transitory computer-readable storage medium, the method comprising:
receiving, by the intermediary from a client application associated with a user account, a first message sent via a transport supported by the client application, the first message including a device identifier to identify a target device of a plurality of registered devices, a command information identifying a command that is supported by the target device and to be performed by the target device, and a response maximum wait time field that identifies a maximum wait time before the intermediary will send a response to the client application in response to receiving the first message;
identifying, by the intermediary based on a stored device registration information for the target device, a transport supported by the target device;
sending, by the intermediary to the target device via the identified transport supported by the target device, a second message including at least the command information; and
sending, by the intermediary to the client application at a time not later than a time indicated by the response maximum wait time field, a response to the first message that includes at least a command status that identifies a status of a performance of the command by the target device.

15. The method of claim 14 wherein the command status in the response is either a command received status indicating that the command has been received but not yet performed by the target device, or a command performed status indicating that the target device has performed the command.

16. The method of claim 14 wherein the sending, by the intermediary to the client application at a time not later than a time indicated by the response maximum wait time field, a response to the first message comprises: determining, by the intermediary, that a response has not been received by the intermediary from the target device indicating that the target device has performed the command;
sending, by the intermediary to the client application at a time not later than the time indicated by the response maximum wait time field, a response to the client application including a command status indicating that the command has not been performed by the target device.

17. A method of claim 14 wherein the response comprises a first response indicating that the command has been received but not yet performed by the target device, the method further comprising:
receiving, by the intermediary from the client application after a time indicated by the response maximum wait time field, a third message requesting a command result from the target device performing the command;
receiving, by the intermediary from the target device at a time after a time indicated by the response maximum wait time field, a second response indicating that the command was performed and including a command result; and
sending, by the intermediary to the client application, a third response including a command status indicating that the command has been performed by the target device and including the command result.

18. The method of claim 14 wherein the sending, by the intermediary to the client application at a time not later than a time indicated by the response maximum wait time field, a response to the first message comprises:
receiving, by the intermediary from the target device at a time before a time indicated by the response maximum wait time field, a first response indicating that the command was performed and including a command result; and
sending, by the intermediary to the client application at a time not later than the time indicated by the response maximum wait time field, a second response including a command status indicating that the command has been performed by the target device and including the command result.

19. A computer-implemented method for executing instructions stored on a non-transitory computer-readable storage medium, the method comprising:
receiving, by the intermediary from a client application associated with a user account, a first message sent via a transport supported by the client application, the first message including a device identifier to identify a target device of a plurality of registered devices, a command information identifying a command that is supported by the target device and to be performed by the target device;
determining that a payload to be delivered to the target device, including at least the command information, is greater in size than a threshold size;
sending, by the intermediary to the target device via a first transport supported by the target device, a second message including a notification of the command information for the target device; and
receiving, by the intermediary from the target device via a second transport supported by the target device, a third message including a request for the command information for the target device; and
sending, by the intermediary to the target device via the second transport, a fourth message that includes the command information including at least the command.

20. The method of claim 19 wherein the fourth message comprises at least the device identifier that identifies the target device and the command information that includes a command name that identifies the command and a command identifier associated with the command information.

21. The method of claim 20 wherein the command information further comprises a command creation time that identifies when the intermediary received the command from the client application, and an expiration time that identifies a time when the command expires after which the target device should not perform the command if not already performed.

22. The method of claim 19 wherein the first transport supported by the target device supports at least a push-based communications that allows the intermediary to initiate a data transfer to the target device, and wherein the second transport supported by the target device supports a pull-based communications that allows the target device to initiate data communications with the intermediary.

23. The method of claim 19 wherein the first transport is unable to deliver payloads that are larger than the threshold size.

24. The method of claim 19 wherein the third message comprises a request for the command information for the target device, the request including at least a command identifier associated with the command information and the device identifier to identify the target device.
